(19) United States
(12) Patent Application Publication
(10) Pub. No.: US 2006/0227969 A1
(43) Pub. Date: Oct. 12, 2006

(54) Visual cryptography system

(75) Inventors: Mark Thomas Johnson, Eindhoven (NL); Pim Theo Tuyls, Eindhoven (NL); Thomas Andreas Maria Kevenaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/548,245

(22) PCT Filed: Mar. 1, 2004
(86) PCT No.: PCT/IB04/50175

§ 371 Date: Sep. 6, 2005

(30) Foreign Application Priority Data
Mar. 11, 2003 (EP) 03100607.5

(51) Int. Cl. H04N 7/167

(52) U.S. Cl. 380/210

(57) ABSTRACT

The present invention relates to a visual cryptography system. The system comprises a first and a second display device (1, 2), arranged for, upon being superimposed on each other, reconstructing a graphical message from two respective shares. At least one of said display devices (1, 2) comprise means for facilitating determination of the resolution and pixel size of the other. At least one, preferably both, of, said display devices (1, 2) is arranged to scale the resolution and pixel size of its share to a mutually supported resolution and pixel size, and preferably to a mutually supported smallest common multiple resolution and pixel size.

The present patent application relates to the field of visual cryptography, and particularly to a system and method for enabling use of two superimposed display devices having different resolution and pixel sizes for reconstruction of a graphical message from two respective shares.

Visual cryptography (M. Naor, A. Shamir: Visual Cryptology, Eurocrypt '94, Springer-Verlag LNCS Vol. 950, Springer-Verlag, 1995, pp1-12) can briefly be described as follows. An image is split into two randomized parts, the image plus a randomization and the randomization itself. Either part contains no information on the original image because of the randomization. However, when both parts are physically overlaid the original image is reconstructed.

If the two parts do not fit together, no information on the original image is revealed and a random image is produced. Therefore if two parties want to communicate using visual cryptography, they have to share the randomization. A basic implementation would be to give a receiving party a transparency containing the randomization. The sender would then use this randomization to randomize the original message, and transmit the randomized message to the receiver, on a transparency or any other means. The receiver puts the two transparencies on top of each other and recovers the message. This scheme can be compared to a one time pad.

A more flexible implementation is obtained when using two display screens, e.g. two Liquid Crystal Display (LCD) screens. A first screen displays the image plus randomization and a second screen displays the randomization itself. If the screens are put on top of each other, i.e. superimposed, the reconstructed image appears.

As described above, reconstruction of the image is performed by superimposing the first and second displays in the correct alignment, so that the user can see the reconstructed graphical message. The reconstruction is performed directly by the human eye and not by a device which might be compromised. This makes use of visual cryptography to communicate secret information more securely.

However, an important problem with prior art attempts to use the above described implementation is that the size and resolution of displays can be very different. As a result, the size of the pixels of the displays will vary. It is then no longer possible to correctly align the pixels, which will cause the reconstruction to fail.

In FIG. 10 of U.S. Pat. No. 5,101,296 is illustrated one prior art approach to solving this problem. This prior art figure shows the geometry of a pair of light-polarizing mosaics where, instead of being in contact, the mosaics are mounted parallel but separated by a distance y, and the viewer's eye is located at a distance z, which requires the intermediate mosaic to have a smaller scale by the ratio z/(z-y) in order for the two mosaics to appear to the eye to be in register over the entire field. Because the two mosaics are separated, changes in viewer position will affect the registration of the mosaics and thereby cause a change in the appearance of the overlapped mosaics.

A shortcoming of the prior art is that it will only work if both displays have pixels with the same aspect ratio, i.e. height/width ratio. Further, this will only work at one point in space, which point will be almost impossible to find, and if it is found, it will disappear again should the viewer start to use the other eye.

Accordingly, it is an object of the present invention to provide an improved apparatus for enabling visual cryptography through superimposing two display screens having different resolutions and/or different pixel aspect ratios.

A further object of the invention is to provide an improved method for enabling visual cryptography through superimposing two display screens having different resolutions and/or different pixel aspect ratios.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

In the drawing, wherein like reference characters denote similar elements throughout the several views:

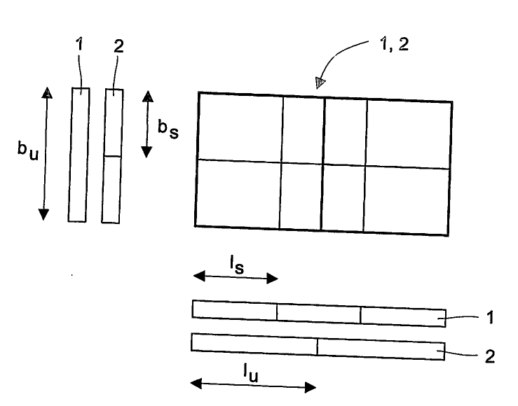

FIG. 1 discloses a schematic illustration of two overlaid displays with different pixel sizes in a view from above and two respective side views.

Visual cryptography, i.e. the building up of images from the superposition of two partial images (shares), neither of which contains information, can e.g. be realized using two identical display screens to display the shares. Using identical displays, it is only necessary to correctly align the images, as the pixel sizes and resolutions of the two displays are identical. In general however, whilst most displays are arranged to have square pixels, (with a parallel arrangement of red, green and blue sub-pixels in color displays) the size and resolution of displays can be very different. As a result, the size of pixels in the displays will vary, typically in the range from 300 microns (80 dpi) to 120 microns (200 dpi). If the two shares are displayed on two displays with different pixel sizes, the visual cryptography approach will fail completely, as the two shares will no longer be aligned at all points of the image as one share will be larger than the other.

FIG. 1 shows a schematic illustration of two overlaid displays 1, 2 with different pixel sizes (lᵤ,bᵤ) and (lₛ,bₛ) respectively, as illustrated in in FIG. 1 by the views from the left and from the bottom respectively of the view from above of the two superimposed displays 1, 2. In order to enable visual cryptography in the case illustrated in FIG. 1, it will be necessary to scale the two shares correctly to the same size, e.g. as illustrated (2lᵤ, bᵤ) and (3lₛ,2bₛ).

In all embodiments this is achieved through providing at least one of the displays with means for facilitating determination of the pixel size of the other. Preferably both displays 1, 2 are provided with means for facilitating determination of the pixel size of the other. This can be achieved in several ways.

As an example, in a first embodiment this determination can be realized through the two displays 1, 2 communicating with each other. Such communication could either take place wirelessly or by optical means, or by any suitable communication means. The displays 1, 2 can transfer information concerning their respective resolutions and pixel sizes, which information can be stored e.g. in their respective display controllers.

As a further example, in a second embodiment the displays 1, 2 can be arranged to carry out a measurement, whereby one of the displays, prefer [symbol] display 2 determines the pixel size of the other display 1. This determination can e.g. be realized through the displays being programmed to generate default test patterns, such as stripe patterns or “vernier” patterns. By measuring the spacing of these patterns, for example with light sensors in the display 2, it will be possible to determine the pixel size of the other display 1. An alternative way of realizing this determination is to let both displays 1, 2 generate test patterns whereupon the differences between these patterns are measured using a vernier method. In this way, also the pixel size of the host (untrusted) display 1 can be established.

Once the pixel size of the two displays 1, 2 have been established, the shares can be scaled to ensure that the visual cryptography will work correctly. In general, this will result in a reduction of the resolution (dpi) of the shares to a resolution which can mutually be supported by both displays 1, 2. As soon as the secure display 2 has received the sizes (l^{u}, ,bᵤ) of the pixels of the host display 1, it will compute the smallest common multiple of its own pixel sizes (lₛ,bₛ) and those of the host display 1. The smallest common multiple will hereafter be denoted (L, B). Hereafter the following two numbers will be computed N₁=L/lₛ and N₂=B/bₛ. The secure display 2 will then generate every pixel of its share N₁ times in the L-direction and N₂ times in the B-direction. The host (untrusted) display 1 will follow the same procedure and display the pixels in its share M₁=L/lᵤ times in the L-direction and M₂=B/bᵤ times in the B-direction. For the overlaid displays 1, 2 illustrated in FIG. 1, the smallest common multiple is (L, B)=(3lₛ,2bₛ)=(2lᵤ,bᵤ). For the secure display N₁=3, N₂=2 and for the host display M₁=2, M₂=1.

In a further embodiment it is assumed that many displays have fixed pixel sizes, (for example 300 micron in laptops, 200 micron in PDA's, 150 microns in phones), and that it would be possible to define certain standard pixels sizes for visual cryptography displays, which assumption of course would require a consensus in the industry. If such a standard was defined, then it would no longer be necessary to measure the pixels size of the displays, as the secure display would have one of a number of a limited number of pixel sizes. In this case, as means for facilitating determination of the resolution and pixel size of the other display, it will be sufficient to display a multiple set of shares on the host device 1, each image corresponding to one of the fixed number of possible resolutions of the secure display device 2. If these shares are displayed sequentially, it is then only necessary to ensure that the secure display is correctly positioned on the host display above the image of correct pixel size. Alternatively, the images at multiple resolution may all be presented simultaneously within the secure display image area, but only a small sect [symbol] will be readable, i.e. that fraction where the images are of the correct size. Once the image of correct resolution has been identified, further secure communication can proceed at this resolution, e.g. after user selection of this resolution, and multiple images are no longer required.

A method for scaling of unequal pixels of two superimposed display devices for enabling reconstruction of a graphical message from two respective shares in visual cryptography, comprise the steps of: providing at least one of said display devices with means for facilitating determination of the resolution and pixel size of the other; and, arranging at least one of said display devices to scale the resolution and pixel size of its share to a mutually supported resolution and pixel size. In a preferred embodiment of the method the step of arranging further comprise arranging both display devices to scale the resolutions and pixel sizes of their respective shares to a mutually supported smallest common multiple resolution and pixel size, based on the above described methodology.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A visual cryptography system, comprising a first and a second display device (1, 2), arranged for, upon being superimposed on each other, reconstructing a graphical message from two respective shares, wherein at least one of said display devices (1, 2) comprise means for facilitating determination of the resolution and pixel size of the other.

2. The visual cryptography system of claim 1, wherein at least one of said display devices (1, 2) is arranged to communicate its resolution and pixel size to the other.

3. The visual cryptography system of claim 1, wherein at least one of said display devices (1, 2) is arranged to perform a measurement of the resolution and pixel size of the other.

4. The visual cryptography system of claim 3, wherein at least one of said display devices (1, 2) is arranged to generate test patterns and said measurement is arranged to determine the resolution and pixel size through measuring the spacing of said test patterns.

5. The visual cryptography system of claim 3, wherein both display devices (1, 2) are arranged to generate test patterns and said measurement is arranged to determine the resolution and pixel sizes of both displays (1, 2) through measuring the difference between said test patterns.

6. The visual cryptography system of claim 1, wherein said means for facilitating determination of the resolution and pixel size of the other display device comprise means for displaying to one of said display devices (1, 2) a set or sequence of image shares corresponding to the possible resolutions and pixel sizes of the other display and means for performing a user selection of a corresponding resolution and pixel size.

7. The visual cryptography system of claim 1, wherein at least one of said display devices (1, 2) is arranged to scale the resolutions and pixel sizes of its share to a mutually supported resolution and pixel size.

8. The visual cryptography system of claim 1, wherein both display devices (1, 2) are arranged to scale the resolutions and pixel sizes of their respective shares to a mutually supported smallest common multiple resolution and pixel size.

9. A method for scaling of unequal pixels of two superimposed display devices for enabling reconstruction of a graphical message from two respective shares in visual cryptography, comprising the steps of:
providing at least one of said display devices with means for facilitating determination of the resolution and pixel size of the other;
arranging at least one of said display devices to scale the resolution and pixel size of its share to a mutually supported resolution and pixel size.

10. The method of claim 9, wherein the step of arranging further comprise:
arranging both display devices to scale the resolutions and pixel sizes of their respective shares to a mutually supported smallest common multiple resolution and pixel size.
